(19) United States
(12) Patent Application Publication
(10) Pub. No.: US 2005/0230509 A1
(43) Pub. Date: Oct. 20, 2005

(54) Angled toothed feed drum for hammermill

(75) Inventor: Carl Bonner, Caldwell, ID (US)

Correspondence Address: ROBERT L. SHAVER;DYKAS, SHAVER & NIPPER, LLP, PO BOX 877, BOISE, ID, 83701-0877, US

(73) Assignee: Diamond Z Manufacturing, Caldwell, ID (US)

(21) Appl. No.: 10/829,086

(22) Filed: Apr. 20, 2004

(51) Int. Cl. B02C 13/286

(52) U.S. Cl. 241/186.4

(57) ABSTRACT

The present invention includes a feed roller for hammermills that includes teeth arranged in rows at an angle with alternating larger and smaller teeth. This arrangement of rows of teeth and larger/smaller teeth on the feed roller of a hammermill increases the grip of the feed roller on the material and intends to move material from the lateral edges towards the center of the hammermill. This is advantageous for grinding, as some lateral motion upon feeding material into the hammermill is desirable.

### BACKGROUND OF THE INVENTION

1. Field of the Invention

The present invention generally relates to hammermills, and more particularly relates to feed rollers of horizontal hammermills.

2. Background Information

One type of hammermill is a horizontal hammermill. A horizontal hammermill has a rotating hammermill with heavy hammers that break apart the material being shredded. Material being fed into the hammermill is typically fed in on a chain. A common feature on horizontal hammermills is a powered cylindrical drum called a feed roller, which is a large cylindrical structure that presses down against the feed belt. This serves to grip material that is on the feed belt and hold it in place as it is fed into the hammermill.

Some type of gripping surface is provided on the feed roller in order to better grip the material being fed into the hammermill. The gripping structure(s) can be teeth, ridges or rails. The typical orientation of such teeth is to have the teeth be cut out of linear metal stock. A section of this linear metal stock is then welded to the outside of the drum and extends from one side of the drum to the other. The linear stock can be cut to form a number of teeth for gripping. A number of such bars of teeth are attached to the drum so that as it rotates teeth are available to catch, hold, and urge forward material being fed into the hammermill.

The present invention overcomes several limitations of the prior art teeth on feed rollers of hammermills. A problem that can be encountered in feed rollers of the prior art is that they tend to feed material straight into the hammermill. The hammers of the hammermill are typically spaced slightly apart. If a piece of wood is fed straight into the hammermill, two hammers of the hammermill may grind off the material, but material that passes in between the two hammer can lodge against the mill shaft, smoke, and jam the hammermill. It would be better if material were pushed forward into the hammermill and/or if the material would move while on the belt, such as to rotate or move laterally. This would prevent material from passing between the hammers of the hammermill, and being pressed against the mill shaft. This would prevent the associated smoking and jamming, and ensure that all of the material is ground by the hammermill teeth. It would also be good to cause material from the edges of the feed box to move towards the center, so that they do not fall or get pushed over the sides of the feed box. Another problem with the prior art feed roller teeth is that a short piece of material can become jammed between the hammers and the teeth, and exert enough force on the feed roller teeth to damage the bearings of the feed roller. If the feed roller were set at an angle, the piece would tend to slip off the teeth rather than be jammed straight into the row of teeth. This would reduce damage to the feed roller bearings.

Additional objects, advantages and novel features of the invention will be set forth in part in the description which follows and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

The present invention solves these problems with a unique configuration of teeth on a feed roller. Such a feed roller is generally cylindrical and therefore has a longitudinal axis down the center of the cylinder. The longitudinal axis is also the axis of rotation. It also has a roller surface on which the teeth in the prior art and the present invention are mounted. One can envision straight lines on the roller surface that are parallel with the longitudinal axis of the feed roller. In the prior art, rows of teeth are typically placed parallel to such straight lines on the roller surface. In the present invention, the rows of teeth are placed on the roller surface so that they are at an angle to the straight lines on the roller surface. The gripper teeth of the hammermill are thus arranged in rows and are angled to the straight lines of the roller surface. The cylinder can also be thought of as having an equator, which is a line that encircles the center of the drum and thus divides it into left and right sides. Any particular row of gripper teeth is placed on a left or right side of the roller surface at an angle to the straight lines on the roller surface. When the row of gripper teeth reaches the equator, for instance when describing a row from left to right, the angle of the row on the left side of the equator becomes opposite to the angle on the left side. Thus, the left side may have an angle of forty-five degrees to the straight lines on the roller surface. When that row reaches the equator, the row of teeth would continue, but at an angle of 315 degrees. Thus, these two rows would form an angle like a chevron on the roller surface. A plurality of such chevron shaped rows would be placed along the roller surface to completely cover the surface with rows of teeth.

The preferred angle for the rows of teeth is approximately forty-five degrees, but other angles would also work equally well. An angle from about seventy degrees to ten degrees would also function in the invention. Besides being angled from the straight lines on the roller surface, the orientation of the teeth may be angled so that they are not radial to the drum. If a line were drawn from the longitudinal axis of the cylinder, with the line being perpendicular to the longitudinal axis of the cylinder, it would pass through the roller surface. The teeth can be arranged so that they are not parallel to such a line, but rather are tilted or angled. This causes them to get a better grip and to feed material into the hammermill better.

Another configuration of the invention is for the teeth to be angled as described above, but for the angled row to have a flattened apex, or a v-shaped apex. This design reflects the fact that the angled rows primarily serve the function of moving material from the lateral edges toward the center, and thus the angle pattern in the center is not as critical as it is on the lateral edges.

Another feature of the device is that the rows of teeth can be arranged so that they are of different heights. For instance, every other, every third, or every fourth tooth, for instance, can be higher than the other teeth. This causes a better grip on the material being processed, and also tends to cause movement in the material, which is desirable for improved grinding.

The purpose of the foregoing Abstract is to enable the United States Patent and Trademark Office and the public generally, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive in nature.

### BRIEF DESCRIPTION OF THE DRAWINGS

FIG. 1 is a perspective drawing of the invention showing chevrons of teeth on a feed drum.

FIG. 2 is a perspective drawing showing the feed drum of the invention in a drum housing of a hammermill.

FIG. 3 is a side view of a horizontal hammermill showing the position of the feed drum in relation to the hammermill.

FIG. 4 is a front view of one configuration of roller teeth, with the footprint for that configuration shown below it.

FIG. 5 is a view of a row of feed roller teeth.

FIG. 6 shows two other possible configurations of feed roller teeth, with the footprint of each of those configurations shown below it.

FIG. 7 shows another two possible configurations of the feed roller teeth, with the footprint of those configurations shown below them.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

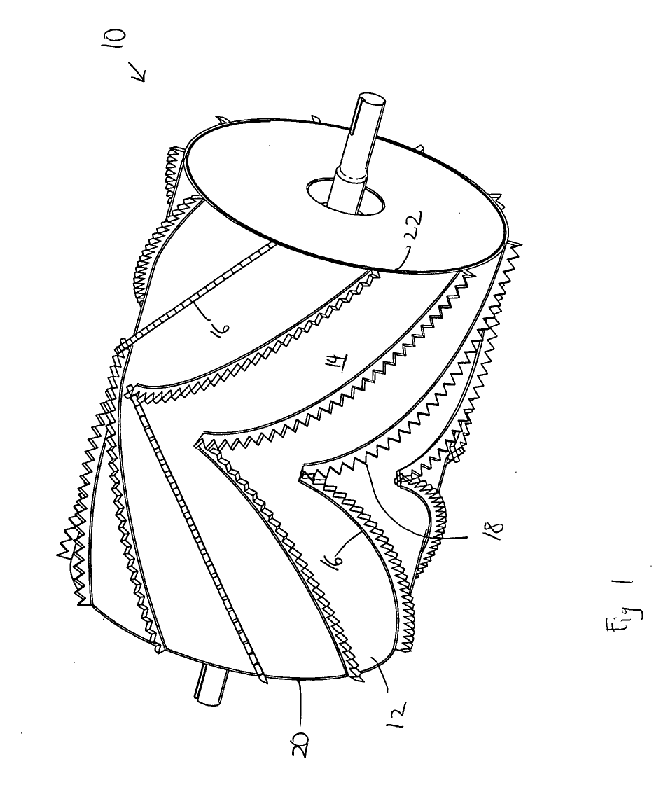

Some preferred embodiments of the preferred embodiment are shown in FIGS. 1 through 7. FIG. 1 shows a perspective view of the feed roller of the present invention. As used herein, “radial” and “radially” refer to directions perpendicular to the axis of rotation, or the longitudinal axis of the cylinder; and “axial” and “axially” refer to directions parallel to the axis of rotation of the cylinder. The feed roller device of the present invention is designated as 10 in the figures. Feed roller 10 includes a generally cylindrical feed roller 12. Extending circumferentially around the axis of rotation of the cylinder is a roller surface 14. Mounted on the roller surface 14 are a number of rows 16 of gripper teeth 18. The rows 16 have their beginnings at the first 20 and second 22 lateral edges of the feed roller 12. According to the invention, the invention has an equator or mid-circumferential center plane 24. As used herein, a “mid-circumferential center plane” is a plane that is perpendicular to the axis of rotation of the roller, located midway between the first lateral edge 20 and the second lateral edge 22.

A feed drum of the type shown can be sized according to the size of the hammermill that it is used with and according to the feed belt feeding the hammermill. Typical dimensions of such a hammermill and an associated feed roller can be a hammermill in which the mill itself is 68 inches wide, the feed chain is 66 inches wide, and the drum is approximately 66 inches wide. Such a drum would have a diameter of 70 inches. It would typically be made of steel, although other substances could be utilized if they were sufficiently strong. The teeth are arranged in rows in which the teeth are 3/4 inches wide and constructed to varying lengths. The rows 16 are curved to fit the curvature of the feed roller 12. The rows 16 would typically be welded to the roller surface 14.

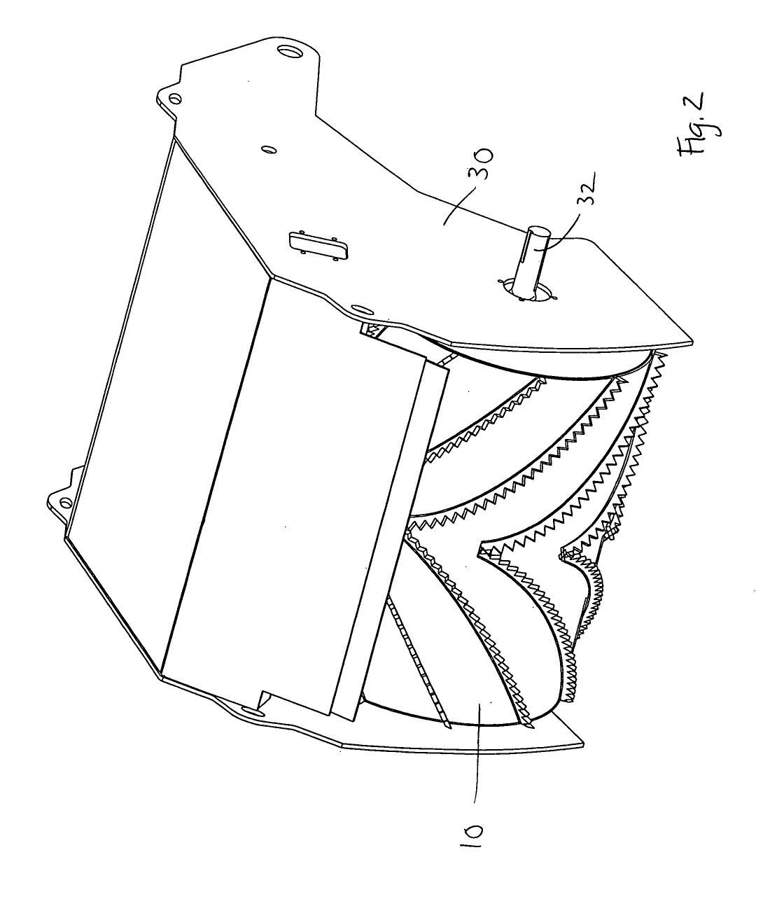

FIG. 2 shows the feed roller 10 of the invention, as it would be mounted in a roller shroud 30 for attachment to a horizontal hammermill. The axle 32 of the feed roller extends through the sides of the roller shroud 30, and would be supported by bearings in the shroud.

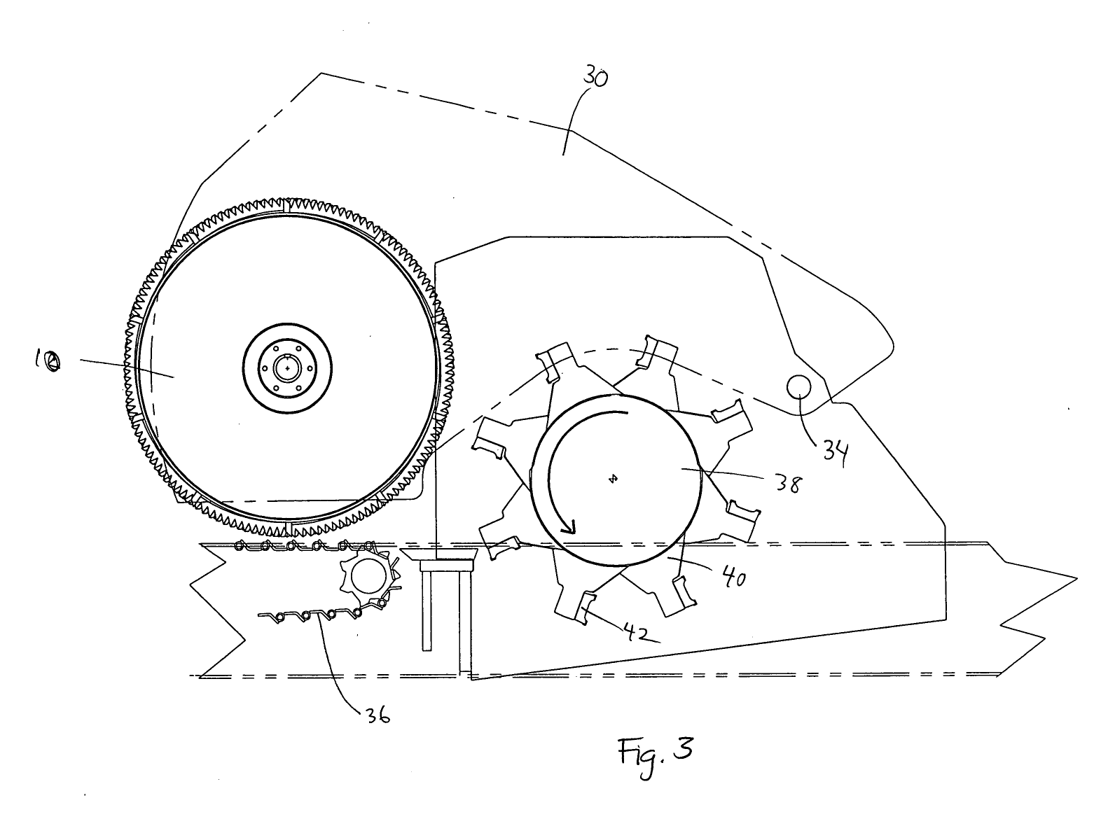

FIG. 3 is a plan view showing the feed roller 10 mounted in the roller shroud 30 in the position that the roller shroud 30 and the feed roller 10 can pivot about a first pivot point 34. The feed roller 10 is mounted above a feed conveyor 36 which carries material into the hammermill. The hammermill is designated 38 and includes hammers 40 with hammer tips 42.

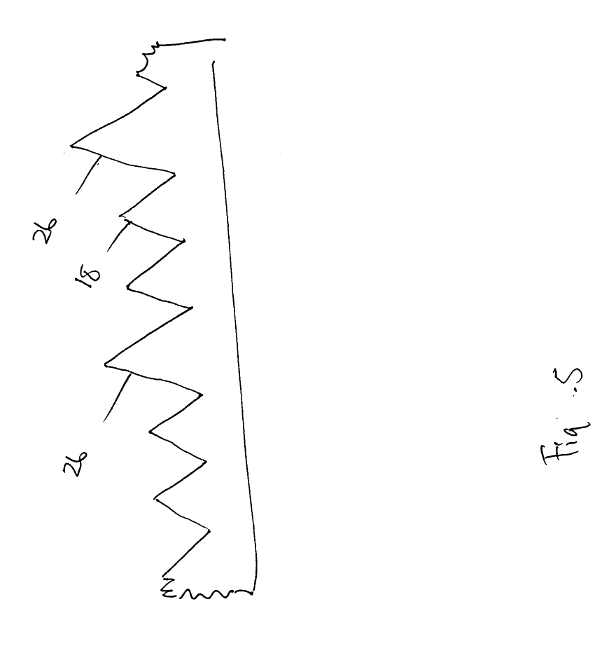

A preferred embodiment of the present invention includes gripper teeth that are configured to include some teeth that are larger than other teeth. This is shown in FIG. 5. One arrangement would have every third or fourth tooth larger than the other teeth. One preferred configuration of the teeth is one in which the teeth are one and a half inches in height and approximately 3/4 inches thick. The large teeth, designated as 26, would be approximately one half to one and a half times taller than their neighboring teeth. The rows are arranged on the roller surface 14 so that they are not parallel with axial lines on the roller surface 14. Instead, they are placed at an angle to the mid-circumferential center plane, or equator, whereas, an axial line would be ninety degrees from the equator. The rows 16 of teeth are arranged to extend from the lateral edges 20, 22 towards the equator and to be at an angle from the equator of approximately twenty to twenty-six degrees. Within that range, the preferred angle is approximately forty to fifty degrees.

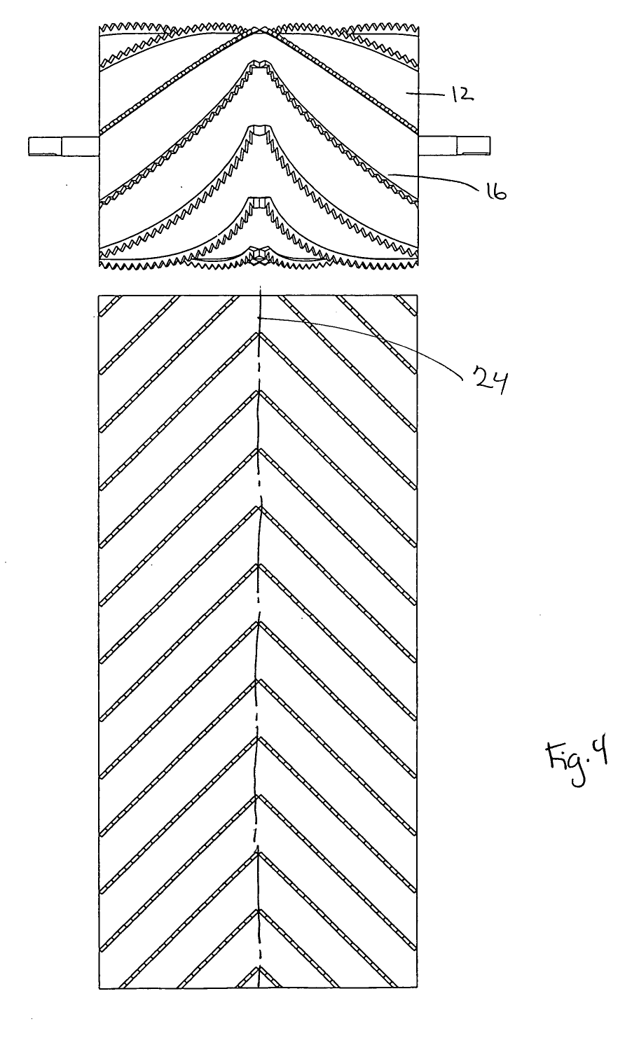

FIG. 4 shows an alternate configuration of the rows 16 on the feed roller 12. Shown below the feed roller is a depiction of the “footprint” 28 of the feed roller 12 shown in FIG. 4.

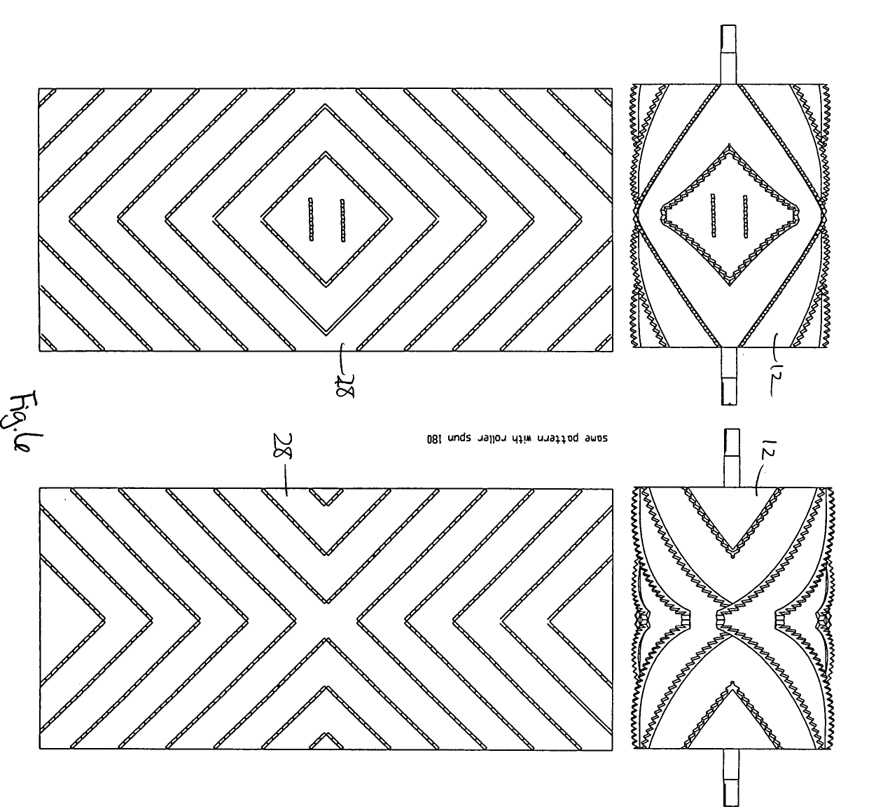

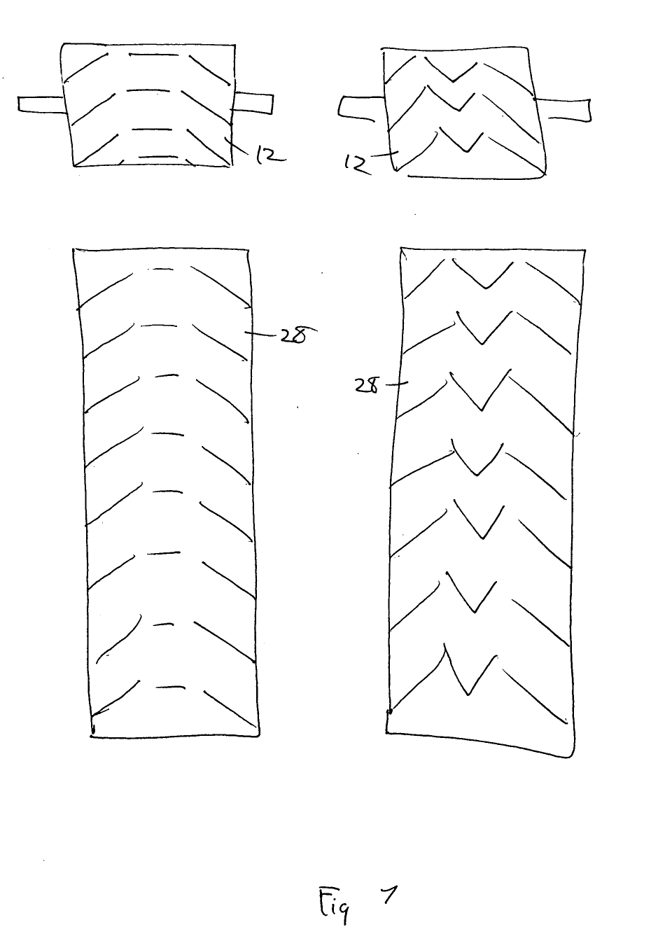

Other configurations of the roller could also be utilized and still fall within the claims of this invention. Other configurations are shown in FIGS. 6 and 7, with the feed roller 12 being shown above and the footprint 28 of each shown below.

An important feature of the invention is that the rows of teeth are set at an angle to the equator of the drum. When rows of teeth at such an angle are present, they press down against material on the feed belt being fed onto the hammermill. In conventional feed mills, such material can be fed straight into the hammermill and some of it can extend between the hammermill teeth. With the feed drum configured as shown in the present invention, material being fed into the hammermill tends to be moved laterally and to be moved from the lateral edges 20, 22 towards the equator 24. The shape and configuration of the rows of teeth, especially when some teeth are higher than others, results in much improved gripping of the material being fed into the hammermill as well as stabilizing the material towards the equator of the drum.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

1. A hammermill feed device, the feed device comprising:
a generally cylindrical feed roller, the feed roller having a longitudinal axis, and a roller surface, with said feed roller having a mid-circumferential center plane centrally located and encircling said feed roller;
a plurality of gripper teeth in rows, said rows of gripper teeth extending from a left and right lateral edge of said feed roller toward said mid-circumferential center plane, with each row angled to be non perpendicular relative to said mid-circumferential center plane, with the angle of the rows on the left side of the roller center plane being equal and opposite to the angle of the rows on the right side of the roller center plane.

2. The hammermill feed device of claim 1 in which said plurality of rows are generally parallel to each other.

3. The hammermill feed device of claim 1 in which said gripper teeth are arranged in said rows in non-uniform teeth heights.

4. The hammermill feed device of claim 1 in which said rows extend from the left and right lateral edge substantially to the mid-circumferential center plane.

5. The hammermill feed device of claim 1 in which said rows extend from said left and right lateral edges, and extend toward said mid-circumferential center plane, and have a non-congruent center portion of gripper teeth rows.

6. The hammermill feed device of claim 1 in which said rows of gripper teeth are angled from said straight lines from 60-30 degrees.

7. The hammermill feed device of claim 1 in which said gripper teeth extend from said roller surface in a direction not parallel to a line extending radially from the longitudinal axis of the feed roller.

8. A hammermill feed device, the feed device comprising:
a generally cylindrical feed roller, the feed roller having a longitudinal axis, and a roller surface, with said feed roller having a mid-circumferential center plane centrally located and encircling said feed roller;
a plurality of gripper teeth in rows, said rows of gripper teeth extending from a left and right lateral edge of said feed roller toward said mid-circumferential center plane, with each row angled to be non perpendicular relative to said mid-circumferential center plane, with the angle of the rows on the left side of the roller center plane being equal and opposite to the angle of the rows on the right side of the roller center plane, with said gripper teeth are configured with non-uniform teeth heights.

9. The hammermill feed device of claim 8 in which said gripper teeth are configured in a repeating pattern of relatively smaller teeth and relatively larger teeth.
